(19) United States
(12) Patent Application Publication
(10) Pub. No.: US 2016/0251882 A1
(43) Pub. Date: Sep. 1, 2016

(54) Door Lock

(71) Applicant: Patrick Dennis, Denham Springs, LA (US)

(72) Inventor: Patrick Dennis, Denham Springs, LA (US)

(21) Appl. No.: 15/047,235

(22) Filed: Feb. 18, 2016

Related U.S. Application Data
(60) Provisional application No. 62/121,556, filed on Feb. 27, 2015.

(51) Int. Cl. E05C 17/02

(52) U.S. Cl. CPC E05C 17/02

(57) ABSTRACT

A door lock for preventing a door from being opened by intruders. The door lock includes a ring having an open central area, wherein the ring can be positioned over a doorknob to prevent the door from being opened. The ring has a substantially circular shape and includes a recessed area that can be positioned over the neck of the doorknob so as to secure the ring onto the doorknob. The ring includes one or more slides thereon for securing the ring in position on the doorknob. The ring is connected to a bracket that is mountable to a doorframe via an elongated chain. The bracket includes a planar panel that can be affixed to the doorframe via any suitable fasteners. Thus, the door lock helps to prevent a door from being opened when installed thereon, and can be removably positioned on the doorknob as desired by the user.

### CROSS REFERENCE TO RELATED APPLICATION

This application claims the benefit of U.S. Provisional Application No. 62/121,556 filed on Feb. 27, 2015. The above identified patent application is herein incorporated by reference in its entirety to provide continuity of disclosure.

### BACKGROUND OF THE INVENTION

### Field of the Invention

The present invention relates to door locks. More specifically, the present invention provides a door lock for ensuring that a door cannot be opened by unauthorized users. The door lock comprises a ring securable around a door knob, wherein the ring is connected to a bracket via an elongated chain. The bracket is adapted to be mounted to a door frame or other suitable support surfaces so as to anchor the device to a permanent structure. The ring is shaped and sized so as to be able to pass over the doorknob. The ring includes a recessed area that fits over the neck of the doorknob such that the ring is removably secured thereto.

Doors commonly include one or more locks in order to prevent the door from being opened in order to provide privacy and security. However, many conventional locks provide little security and can be easily broken or circumvented. Some doors include locks built-into the doorknob, but such locks have limited strength and durability. An intruder desiring to pass through the door can apply sufficient force to dislodge or break the lock built-into the doorknob.

Many doors include chain locks wherein a sliding frame is mounted on a door and a bracket is affixed to a door frame. A chain extends from the bracket and includes a protrusion on an end thereof that can be removably secured within a sliding frame. Such locks allow a door to be partially opened to a certain extent in order to allow the user to see outside without fully opening the door. However, by allowing the door to be partially opened, the chain is exposed and can be cut or broken by an unauthorized user. Further, the sliding lock is not particularly secure and may also be broken or damaged.

In light of the devices disclosed in the prior art, it is submitted that the present invention substantially diverges in design elements from the prior art and consequently it is clear that there is a need in the art for an improvement to existing door lock devices. In this regard the instant invention substantially fulfills these needs.

### SUMMARY OF THE INVENTION

In view of the foregoing disadvantages inherent in the known types of door locks now present in the prior art, the present invention provides a new door lock wherein the same can be utilized for providing convenience for the user when securing a door so as to prevent entry by intruders and other unauthorized users.

It is therefore an object of the present invention to provide a new and improved door lock that comprises a ring securable around a door knob, wherein the ring is connected to a bracket mounted to a doorframe via an elongated chain.

It is another object of the present invention to provide a door lock comprising a ring having a continuous body that is shaped so as to fit around a doorknob, wherein the ring includes a recessed portion adapted to be secured about the neck of the doorknob so as to prevent the ring from being removed from said doorknob.

Another object of the present invention is to provide a door lock comprising a bracket that is mountable to a door frame via one or more fasteners, such as screws.

Yet another object of the present invention is to provide a door lock having a bracket that includes a hook thereon, wherein the chain of the door lock can be wrapped around said hook so as to prevent the door from being opened.

Yet another object of the present invention is to provide a door lock having a chain of sufficient length to allow the door to be partially opened when said door lock is installed on said door so as to allow the user to see outside without fully opening the door.

Another object of the present invention is to provide a door lock that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the door lock of the present invention.

FIG. 2 shows a frontal view of the door lock as installed on a door in a first configuration.

FIG. 3 shows a frontal view of the door lock in a second configuration.

### DETAILED DESCRIPTION OF THE INVENTION

Reference is made herein to the attached drawings. Like reference numerals are used throughout the drawings to depict like or similar elements of the door lock. For the purposes of presenting a brief and clear description of the present invention, the preferred embodiment will be discussed as used for locking a door so as to prevent access by intruders. The figures are intended for representative purposes only and should not be considered to be limiting in any respect.

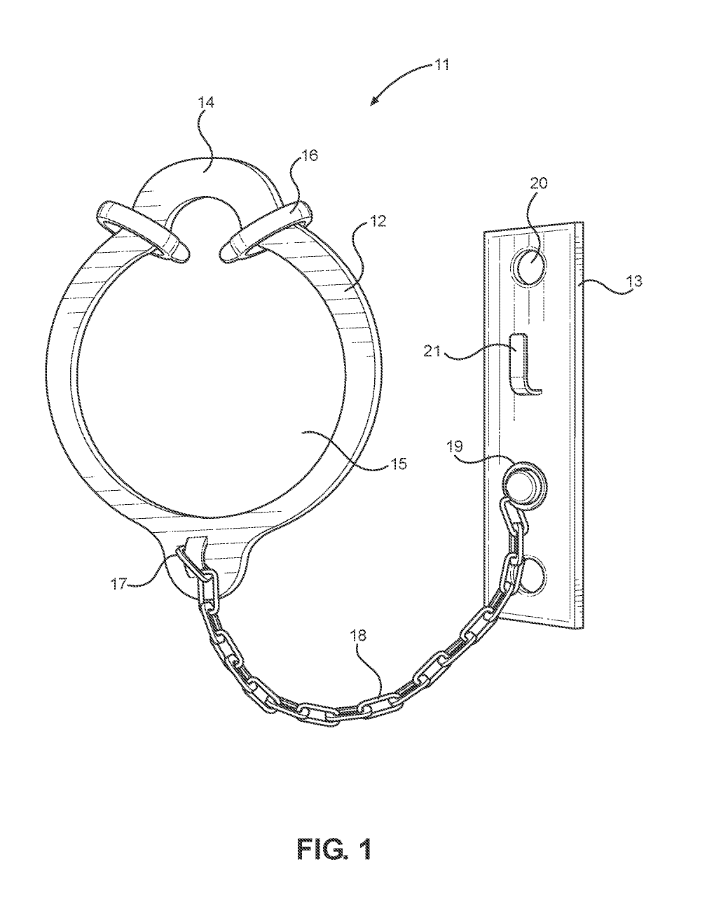

Referring now to FIG. 1, there is shown a perspective view of an embodiment of the door lock of the present invention. The door lock 11 comprises a ring 12 secured to a bracket 13 via a chain 18. The ring 12 comprises a continuous body and defines an open central area 15. The ring 12 preferably has a substantially circular construction, wherein the open central area 15 is configured to be placed over a doorknob. The ring 12 further includes a recessed area 14 thereon configured to receive and support a neck of a doorknob. In this way, the circular shape of the ring 12 allows the ring 12 to be passed over a doorknob, and the recessed area 14 is adapted to be positioned over the neck of the doorknob to removably fasten the ring 12 thereto.

The ring 12 further includes one or more slides 16 adapted to maintain the ring 12 in a desired position on a doorknob. The slides 16 comprise loops that encircle a portion of the ring 12. The slides 16 may further include a nub or protrusion thereon. Once the ring 12 is positioned over a doorknob, the slides 16 can be adjusted so as to be directed towards the open central area 15 defined by the ring 12 so as to limit the movement of the ring 12 about the doorknob. In this way, the slides 16 help to secure the ring 12 on the doorknob and prevent the ring 12 from being removed therefrom.

An elongated chain 18 includes a first end 17 and a second end 19, wherein the first end 17 is affixed to a portion of the ring 12. The chain 18 is preferably a metal chain composed of a plurality of links. The chain 18 is composed of a strong and durable material so that it cannot be easily broken, cut, or otherwise damaged. In this way, the chain 18 helps to improve the security of the door, and prevents an unauthorized user from breaking or disabling the door lock 11.

The second end of the chain 18 is affixed to the bracket 13 that is mounted to a door frame. The bracket 13 comprises a planar panel having one or more openings 20 thereon through which fasteners, such as screws, can be inserted for securing the bracket 13 to the doorframe. Preferably, the bracket 13 comprises a rectangular configuration, wherein at least one opening 20 is positioned on the upper end thereof and at least one opening 20 is positioned on the lower end thereof. The bracket 13 further includes a hook 21 thereon around which a portion of the chain 18 can be positioned to secure the ring 12 around a doorknob in one configuration. Preferably, the hook 21 is located on the bracket 13 between the upper end and the lower end. Most preferably, the hook 21 is centrally located on the bracket 13.

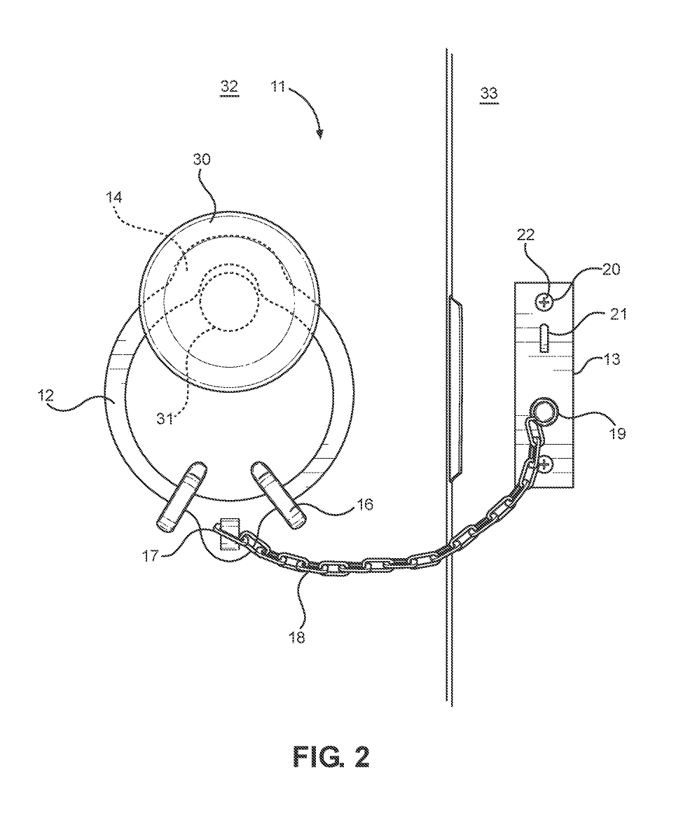

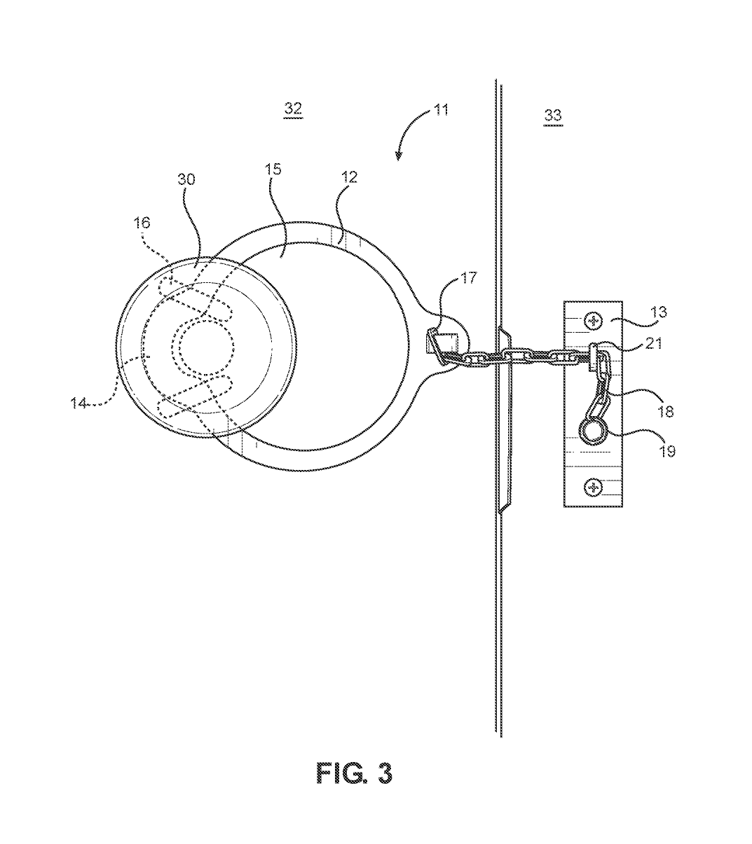

Referring now to FIGS. 2 and 3, there are shown frontals view of the door lock 11 as removably secured to a doorknob of a door in different configurations. In operation, the bracket 13 is mounted to a doorframe 33 via any suitable fasteners 22, such as screws or nails, among others. The fasteners 22 are inserted through the openings 20 on the bracket 13 so as to affix the bracket 13 to the door frame 33. The bracket 13 is adapted to rest flush against the doorframe 33 when installed thereon.

The open central area of the ring 12 can be aligned with the doorknob 30 so that the ring 12 can be placed thereon. Once the ring 12 is positioned over the doorknob 30, the recessed area 14 of the ring 12 is positioned around the neck 31 of the doorknob 30. In this way, the ring 12 is removably fastened thereto and cannot be unfastened without properly realigning the central open area of the ring 12 with the doorknob 30. Thus, the ring 12 is securely positioned over the doorknob 30 and the door 32 is unable to be fully opened due to the connection of the ring 12 to the bracket 13.

In a first configuration, the elongated chain 18 extends from the bracket 13 on the doorframe 33 to the ring 12 positioned around the doorknob 30. The chain 18 is sufficiently long so that the user can partially open the door so as to be able to see outside. This allows a user to check outside without being fully exposed to any potential danger.

In a second configuration, the chain 18 is wrapped around a hook 21 positioned on the bracket 13. By wrapping the chain 18 around the hook 21, the length of the chain 18 is effectively shortened. Thus, in the second configuration, the door 32 is unable to be opened as the chain 18 does not have sufficient slack to allow the door to be partially opened. This prevents unauthorized users from being able to partially open the door, exposing the chain 18.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A door lock, comprising:
a ring having an open central area, wherein said ring is adapted to be disposed over a doorknob to prevent a door from being opened;
an elongated chain having a first end and a second end, wherein said first end is affixed to said ring and wherein said second end is affixed to a bracket;
said bracket adapted to be mounted to a support surface.

2) The door lock of claim 1, wherein said ring comprises a substantially circular configuration.

3) The door lock of claim 2, wherein said ring further comprises a recessed area adapted to be positioned about a neck of said doorknob.

4) The door lock of claim 1, wherein said ring comprises a continuous body.

5) The door lock of claim 1, wherein said elongated chain comprises a plurality of links.

6) The door lock of claim 1, wherein said bracket comprises a planar panel.

7) The door lock of claim 6, wherein said bracket further comprises one or more openings through which fasteners can be positioned.

8) The door lock of claim 1, wherein said bracket comprises a hook thereon, wherein said hook is adapted to have a portion of said elongated chain wrapped therearound.

9) The door lock of claim 1, further comprising one or more slides positioned on said ring, wherein said slides are adapted to secure said ring on said doorknob.
